(19) United States
(12) Patent Application Publication
(10) Pub. No.: US 2020/0104586 A1
(43) Pub. Date: Apr. 2, 2020

(54) METHOD AND SYSTEM FOR MANUAL EDITING OF CHARACTER RECOGNITION RESULTS

(71) Applicant: Konica Minolta Laboratory U.S.A., Inc., San Mateo, CA (US)

(72) Inventor: Daisuke TAKAHASHI, Foster City, CA (US)

(73) Assignee: Konica Minolta Laboratory U.S.A., Inc., San Mateo, CA (US)

(21) Appl. No.: 16/145,671

(22) Filed: Sep. 28, 2018

(51) Int. Cl. G06K 9/00; G06F 17/24; G06F 16/53; G06K 9/32

(52) U.S. Cl. CPC G06K 9/00456; G06K 9/3233; G06F 16/53; G06F 17/24

(57) ABSTRACT

A method, a non-transitory computer readable medium, and a system are disclosed for displaying images from a character recognition application on a display window. The method includes uploading an original image to be processed by a character recognition program; designating one or more regions on the original image as regions of interest; converting the original image into an editable document using the character recognition program, each of the regions of interest being converted into a corresponding editable field; displaying the original image on one portion of the display window, and the editable document in a table on an other portion of the display window; and validating the editable document by comparing an image of a region of interest from the original image with the corresponding editable field by superimposing the image of the region of interest on the other portion of the display window.

### FIELD OF THE INVENTION

The present disclosure generally relates to a system and method for manual editing of character recognition results, for example, for the manual editing of optical character recognition/intelligent character recognition (OCR/ICR)

### DOCUMENTS

### Background of the Invention

Optical character recognition (OCR) is the mechanical or electronic conversion of images of a typed or printed text into machine-encoded text. OCR images can be generated from a scanned document, a photo of a document, a scene-photo, or from subtitles superimposed on an image. OCR is widely used, for example, as a form of information entry from printed paper data records, documents, invoices, bank statements, computerized receipts, business cards, mail, printouts of static-data, or any suitable documentation, and can be a method of digitizing printed texts so that they can be electronically edited, searched, stored, displayed on-line, and used in machine processes such as cognitive computing, machine translation, text-to-speech, key data, and text mining.

Intelligent character recognition (ICR) is a type of optical character recognition, which recognizes handwriting that allows fonts and different styles of handwriting to be learned by a computer during processing to improve accuracy and recognition levels. Most ICR software has a self-learning system referred to as a neural network, which automatically updates the recognition database for new handwriting patterns. ICR software can extend the usefulness of scanning devices for the purpose of document processing, from printed character recognition (i.e., a function of OCR) to hand-written matter recognition.

After OCR/ICR process is performed by an OCR/ICR program, it is often necessary for an editor (i.e., a human) to validate or correct results by visually comparing the results to the original image. The validation or correction process can involve object searches, result field validation, and character-by-character text validation or correction.

For example, in object searches, the editor searches for original image segments which correspond to fields that the editor is currently reviewing and/or editing. Result field validations can also be required when the editor is working on editable text fields which are arranged differently than the original location of the image and text images. For example, the editable fields are often displayed as a table or a list due to a limitation of available space in a display. In this case, the editor may have hard time to link editable fields to image segments since object correspondence between the original image and editable image in terms of relative positions are already changed (i.e., broken). Therefore, the editor will be required to another step to verify whether the editor is working on the correct fields. For example, the editor may use key values which are linked to editable fields which the editor is working on. After two objects (an editable text and an image segment) are designated (or identified), the editor needs to compare them character-by-character to determine if any discrepancies between the objects exist and if a correction and/or revision is necessary.

One approach is to design a display window (or graphical user interface (GUI)) or screen of a computer device to help the editor perform these steps by displaying the editable texts and the original document image from which the editable text has been generated in a side-by-side view (JP2012-73749A). The side-by-side approach can be effective when comparisons are only performed on a relatively small document or a small portion of a larger document image. However, the side-by-side display of an entire original document may not be sufficient when the comparison involves an entire or a larger portion of the original document. In addition, text is often unrecognizable in a side-by-side comparison, for example, when a size of the screen or display is relatively small, for example, on a laptop computer.

Even with improvements in OCR/ICR technology, editing of electronic documents generated by OCR/ICR programs still require human involvement in the validation of the results obtained by the OCR/ICR process. During an editing process, for example, the editor needs to visually compare texts of the original image to the corresponding results to determine if any discrepancies between the original document image and the corresponding results are present. In order to make object searches intuitive, one approach is to put an entirety of the original document image on the left side of a page, and on the right side, put editable texts based upon their corresponding image segment coordinates in the image. Although the editor can link editable texts to their original image segments rather easily, distances between them does not make character-by-character comparison as easy as it should.

When the original image is displayed on the left side of the display window (or GUI) and the results from an OCR/ICR are displayed on the right side of the display window, it can be burdensome for an editor to determine the original location of editable fields are arranged in a table or list, the editor has to switch his/her eyes right-to-left (vice-versa) to conduct character-by-character comparisons. In addition, typically an entirety of the document image on the left side needs to fit into a half size of a page, such that often the items displayed on the right-side (and accordingly font-sizes) may be too small to be easily recognized, and/or the results displayed on the right side of the screen can be rather ugly or unpleasant.

Accordingly, it would be desirable to have a system and method for manual editing of OCR/ICR (Optical Character Recognition/Intelligent Character Recognition) results, which is intuitive and user-friendly.

### SUMMARY OF THE INVENTION

In consideration of the above issues, it would be desirable to have a method and system for editing OCR/ICR results, which can reduce the editor's burden (object search and comparison) when the OCR/ICR results are validated and corrected.

A method is disclosed for displaying images from a character recognition application on a display window, the method comprising: uploading an original image to be processed by a character recognition program; designating one or more regions on the original image as regions of interest; converting the original image into an editable document using the character recognition program, each of the regions of interest being converted into a corresponding editable field; displaying the original image on one portion of the display window, and the editable document in a table on an other portion of the display window; and validating the editable document by comparing an image of a region of interest from the original image with the corresponding editable field by superimposing the image of the region of interest on the other portion of the display window.

A non-transitory computer readable medium storing computer readable program code executed by a processor for displaying images from a character recognition application on a display window is disclosed, the process comprising: uploading an original image to be processed by a character recognition program; designating one or more regions on the original image as regions of interest; converting the original image into an editable document using the character recognition program, each of the regions of interest being converted into a corresponding editable field; displaying the original image on one portion of a display window, and the editable document in a table on an other portion of the display window; and validating the editable document by comparing an image of a region of interest from the original image with the corresponding editable field by superimposing the image of the region of interest on the other portion of the display window.

A system is disclosed for displaying images from a character recognition application, the system comprising: a client device having a display window, and a processor configured to: upload an original image to be processed by a character recognition program; designate one or more regions on the original image as regions of interest; convert the original image into an editable document using the character recognition program, each of the regions of interest being converted into a corresponding editable field; display the original image on one portion of the display window, and the editable document in a table on an other portion of the display window; and validate the editable document by comparing an image of a region of interest from the original image with the corresponding editable field by superimposing the image of the region of interest on the other portion of the display window.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of a printer or image forming apparatus, which is capable of scanning an original document for OCR/ICR processing in accordance with an exemplary embodiment.

FIG. 2 is an illustration of a printer or image forming apparatus as shown in FIG. 1.

FIG. 3 is an illustration of a client device in accordance with an exemplary embodiment.

FIG. 4 is an illustration of a display screen (or display window) on a client device showing an original document image and an editable version of the original document is a side-by-side comparison.

FIG. 5 is an illustration of a display screen (or display window) on a client device showing an original document image on one side and an editable version of a portion of the original document on an other side in accordance with an exemplary embodiment.

FIG. 6A is an illustration of an image to be processed by the OCR/ICR software application in accordance with an exemplary embodiment.

FIG. 6B is an illustration of exemplary predefined regions of interests (ROIs) in accordance with an exemplary embodiment.

FIG. 6C is an illustration of the exemplary predefined regions of interests are OCR/ICR processing illustrating the use of bounding boxes.

FIGS. 7A and 7B are illustrations of cropped text image displays in accordance with an exemplary embodiment.

FIG. 8 is an illustration of a bounding box display in accordance with an exemplary embodiment.

FIG. 9 is an illustration of a cropped text image display in accordance with an exemplary embodiment.

FIG. 10 is an illustration of a bounding box visualization in accordance with an exemplary embodiment.

FIG. 11 is an illustration of a registration process and the OCR/ICR process in accordance with an exemplary embodiment.

FIG. 12 is an illustration of a portion of the registration process in accordance with an exemplary embodiment.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

In accordance with an exemplary embodiment, the system and method as disclosed can provide a relatively simple character-by-character comparisons between editable text (or images) and their corresponding image segments. The method and system as disclosed can also provide on-demand display of a designated image segment on a one-by-one basis using an editable field and a corresponding image from the original document.

In addition, additional location information of the original image segments which the editor is currently working on in the image can be provided. The method and system, for example can avoid visually unpleasant layout displays caused by overlaying editable fields onto an original image, and still providing an entirety of an original document image (i.e., context of the original document image) by displaying the original document image on one side (for example, the left side of the display window).

In accordance with an exemplary embodiment, the system and method by displaying on a display panel (or display window), for example, a graphical user interface (GUI), a table or list form is retained for the converted images with editable fields on the right side of a page. The table or list being, for example, an arrangement of columns and rows that organizes and positions data from the original image. On the left side, the display panel shows an entirety of the original document image whose width fits into a half width of a page (display window).

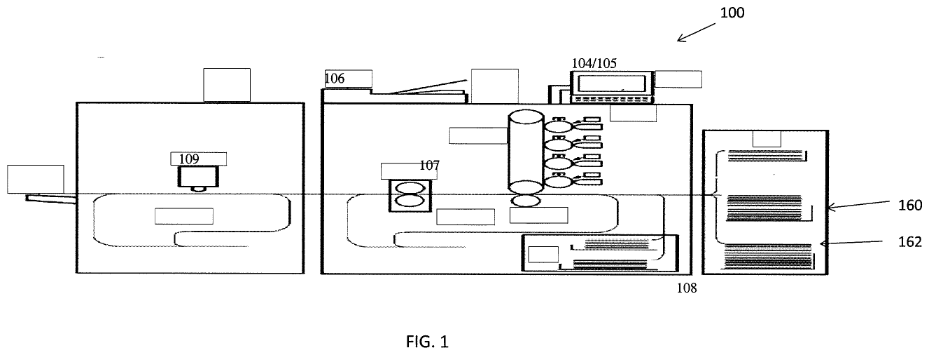

FIG. 1 is an illustration of a printer (or image forming apparatus) 100, which is capable of scanning an original image for OCR/ICR processing in accordance with an exemplary embodiment. The printer 100 can include an input unit 104, a display unit or graphical user interface (GUI) 105, a scanner engine 106, a printer engine 107, a plurality of paper trays 108, and a colorimeter 109. As shown in FIG. 1, each of the plurality of paper trays 108 can be configured to hold a print media 160, for example, a stack 162 of print media (or paper) 160 for printing an editable image (or editable document) after processing by an OCR/ICR program and edited as disclosed herein. The print media 160, for example, can be a paper or paper-like media having one or more print media attributes.

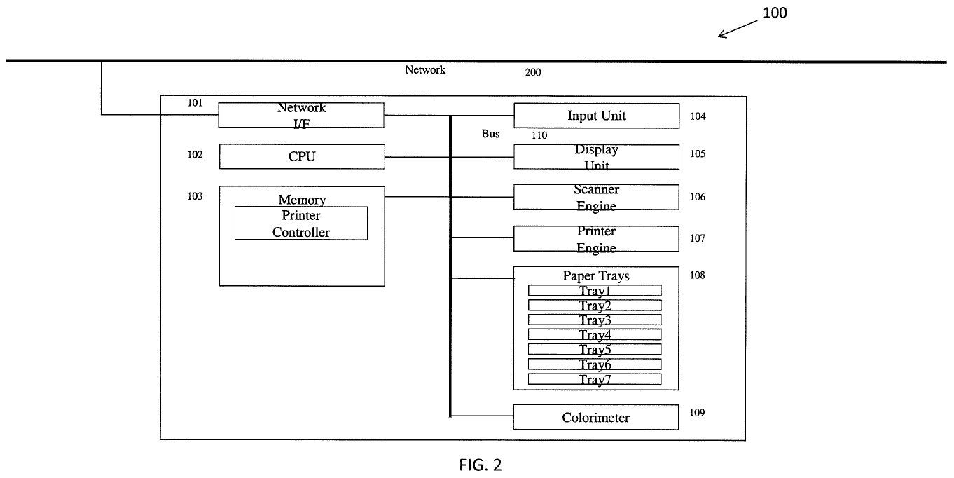

FIG. 2 is a diagram of the printer 100 as shown in FIG. 1. The printer 100 can include a network interface (I/F) 101, which is connected to a communication network (or network) 200, a processor or central processing unit (CPU) 102, and one or more memories 103 for storing software programs and data (such as files to be printed). For example, the software programs can include a printer controller. The processor or CPU carries out the instructions of a computer program, which operates and/or controls at least a portion of the functionality of the printer 100. The printer 100 can also include the input unit 104, the display unit or graphical user interface (GUI) 105, the scanner engine (or scanner) 106, the printer engine 107, at least one paper tray 108, and the plurality of paper trays, 108, for example, Tray 1, Tray 2, Tray 3, Tray 4 . . . Tray N, and the colorimeter 109. The paper tray 108 can include a bin or tray, which holds a stack of a print media, for example, a paper or a paper-like product. A bus 110 can connect the various components 101, 102, 103, 104, 105, 106, 107, 108, 109 within the printer 100.

In accordance with an exemplary embodiment, an image processing section within the printer 100 can carry out various image processing under the control of a print controller or CPU 102, and sends the processed print image data to the print engine 107. The image processing section can also include a scanner section (scanner 106) for optically reading a document, for example, for OCR/ICR processing as disclosed herein. The scanner section receives the image from the scanner 106 and converts the image into a digital image, which can be process with an OCR/ICR program to produce an editable document. The print engine 107 forms an image on a print media (or recording sheet) based on the image data sent from the image processing section. The central processing unit (CPU) (or processor) 102 and the memory 103 can include a program for RIP processing (Raster Image Processing), which is a process for converting print data included in a print job into Raster Image data to be used in the printer or print engine 107.

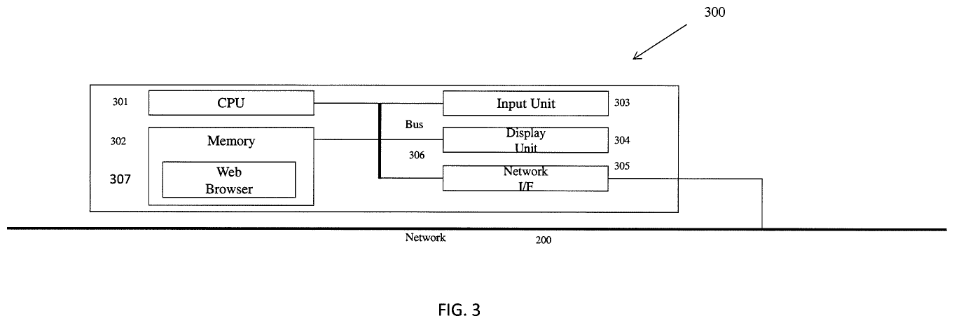

The CPU 102 can also include an operating system (OS), which acts as an intermediary between the software programs and hardware components within the printer 100. The operating system (OS) manages the computer hardware and provides common services for efficient execution of various software applications. In accordance with an exemplary embodiment, the printer controller can process the data and job information received from a client device 300 (FIG. 3) to generate a print image.

The network I/F 101 performs data transfer with the client device 300. The printer controller can be programmed to process data and control various other components of the multi-function peripheral to carry out the various methods described herein. In accordance with an exemplary embodiment, the operation of printer section commences when the printer section receives data for a print job from the client device 300 (FIG. 3) via the network I/F 101. The data for the print job may include any kind of page description languages (PDLs), such as PostScript® (PS), Printer Control Language (PCL), Portable Document Format (PDF), and/or XML Paper Specification (XPS). Examples of a printer 100 consistent with exemplary embodiments of the disclosure include, but are not limited to, a multi-function peripheral (MFP), a laser beam printer (LBP), an LED printer, and a multi-function laser beam printer including copy function.

In accordance with an exemplary embodiment, the communication network or network 200 between the printer 100 and the client device 300 can be a public telecommunication line and/or a network (for example, LAN or WAN). Examples of the communication network 200 can include any telecommunication line and/or network consistent with embodiments of the disclosure including, but are not limited to, telecommunication or telephone lines, the Internet, an intranet, a local area network (LAN) as shown, a wide area network (WAN) and/or a wireless connection using radio frequency (RF), infrared (IR) transmission, and/or near-field communication (NFC).

FIG. 3 is an illustration of a client device 300 in accordance with an exemplary embodiment. As shown in FIG. 3, the client device 300 can include a processor or central processing unit (CPU) 301, and one or more memories 302 for storing software programs (for example, a universal printing software and one or more original vendor printing software (i.e., vendor printing software) and data (such as files to be printed) and a web browser 307. The processor or CPU 301 carries out the instructions of a computer program, which operates and/or controls at least a portion of the functionality of the client device 300. The client device 300 can also include an input unit 303, a display unit or graphical user interface (GUI) 304, and a network interface (I/F) 305, which is connected to a communication network (or network) 200. A bus 306 can connect the various components 301, 302, 303, 304, 305 within the client device 300.

In accordance with an exemplary embodiment, the processor or CPU 301 carries out the instructions of a computer program, which operates and/or controls at least a portion of the functionality of the client device 300. The client device 300 includes an operating system (OS), which manages the computer hardware and provides common services for efficient execution of various software programs. The software programs can include, for example, printing software (i.e., universal printing software or vendor printing software), which can control transmission of data for a print job from the client device 300 to the printer 100. For example, the memory 302 can include application software, for example, a software application or document processing program configured to execute the processes as described herein via an optical character recognition (OCR) and/or an intelligent character recognition (ICR) process.

Embodiments of the invention may be implemented on virtually any type of client device 300, regardless of the platform being used. For example, the client device 300 may be a mobile device (e.g., laptop computer, smart phone, personal digital assistant, tablet computer, or other mobile device), a desktop computer, or any other type of computing device or devices that includes at least the minimum processing power, memory, and input and output device(s) to perform one or more embodiments of the invention.

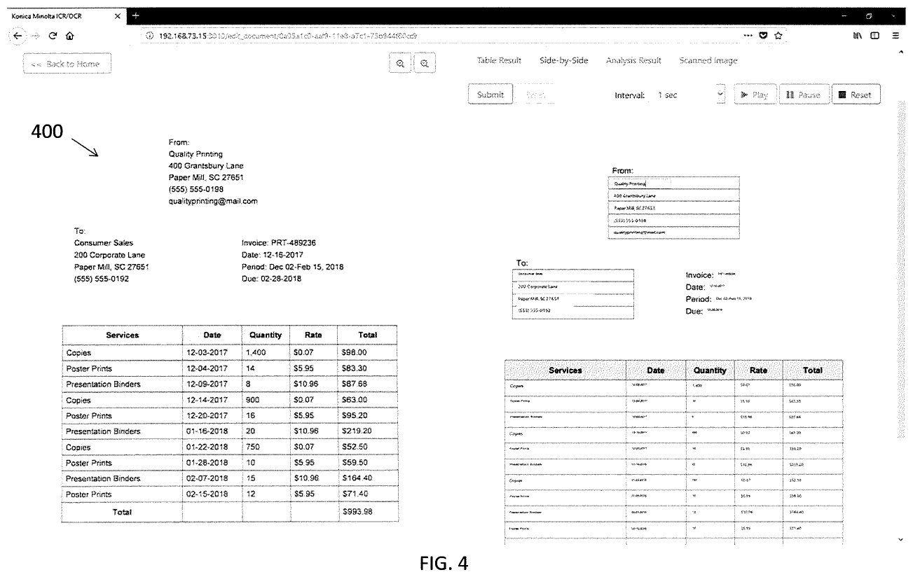

FIG. 4 is an illustration of a display screen (or window) 400 on a client device showing an original document image and an editable version of the original document is a side-by-side comparison. As shown in FIG. 4, the results of the OCR/ICR process can be overlaid on the blank image of the original document as background on one side (i.e., right side) of the display or window, and full context or text of the original document on an other side (i.e., left side) of the display or window. The original document on the left side of the display can be corrected from image shift and rotation which occur during the scanning process.

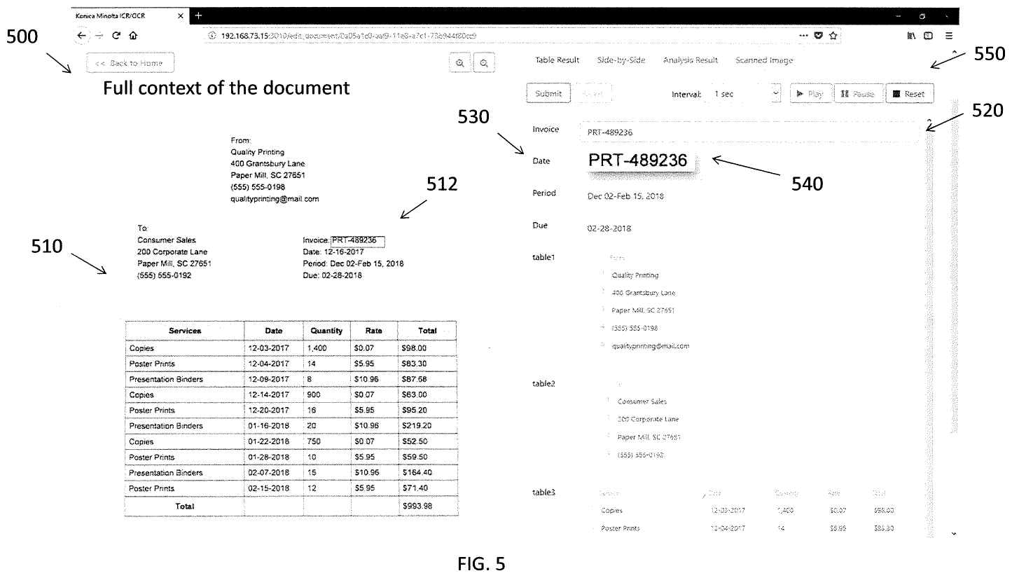

FIG. 5 is an illustration of a display screen or window (for example, a graphical user interface) 500 on a client device 300 (or optionally a printer 100) showing an original document image 510 on one side (i.e., left side of the display screen) and an editable version 520 of a portion of the original document on an other side (i.e., right side of the display screen) in accordance with an exemplary embodiment. As shown in FIG. 5, on the left side, the original image is displayed, and wherein the width of the original image fits into a half width of a page (or window) in order to avoid unnecessary shrink in font-size. In accordance with an exemplary embodiment, for example, the editable fields 520 on the right side of the screen 500 are presented in a table or list form 530 on the right side of the page (or window). As set forth, the table or list can be for example, an arrangement of columns and rows that organizes and positions data from the original image. The window 500 preferably includes a plurality of instructional or format buttons or tabs 550 for converting the original image into an editable document. For example, the instructional and/or format buttons or tabs 550 can include “Table Result”, “Side-by-Side”, “Analysis Result”, “Scanned Image”, “Submit”, “Reset”, “Interval” and series of voice buttons, such as “Play”, “Pause”, and “Reset”.

In accordance with an exemplary embodiment, the results of the OCR/ICR process can be shown in a table or list format by selection of the “Table Result” tab, for depicting the results of the OCR/ICR process in a table or list format on one side (i.e., right side) of the display or window, and full context or text of the original document on an other side (i.e., left side) of the display or window. In accordance with an alternative embodiment, the original image and the editable image can be displayed in a side-by-side format having a similar font and layout. In addition, the program can include an “Analysis Result” feature, for example, which displays all processed regions of interest which are identified by OCR/ICR processing. Processed regions of interest in the same group are drawn in the same color. For example, regions of interest which belong to the same column of a table are drawn in the same color. In addition, if the editor wishes, the scanned image in an original format before OCR/ICR processing or after OCR/ICR processing during any stage of the editable process can be displayed on the display unit (or window) without the other of the scanned image or the editable image. For example, an image can be scaled, shifted, and/or rotated to get aligned to the predefined regions of interest during OCR/ICR processing.

The listing of instructional and/or format buttons or tabs 550 can also include a “Submit” button for submitting the editor's revised results to update the result database of the document, and a “Reset” button, for resetting the editable portion In addition, the editable document can include a preset program for automatically reviewing the editable document having a preset interval, for example, 1 second to 5 seconds, per cropped image on the editable document, which can be programmed to begin on the first line of the editable image and continue line by line displaying the cropped image and the corresponding editable text unit the end of the editable document is reached. In addition, a voice button can be selected in which the cropped image can be played or spoken using a text to speech software application. The text to speech software speaks a text in an editable field and pauses by a preset interval. This function helps the editor validate the OCR/ICR processed results audibly. The voice portion can include, for example, play, pause, and reset buttons.

In accordance with an exemplary embodiment, for example, the editable fields 520 for an invoice (or bill), can include, “Invoice number”, “Date”, “Period”, “Due”, “table 1”, “table 2”, and “table 3”. In accordance with an exemplary embodiment, the OCR/ICR operation is performed based upon predefined regions of interest (ROIs) 512 of a designated format. For example, the invoice number (i.e., cropped image) can be one of the predefined ROIs 512, which upon moving, for example, the cursor to the corresponding table or list on the editable document displays the cropped image. As shown in FIG. 5, the cropped image (for example, text) from the ROI 512 from the original document or image is superimposed (i.e., displayed) on the right side of the page (or window) in a general vicinity, for example, above the editable table or list, below the editable table or list, to the right of the editable table or list, or to the left of the editable table or list. For example, in accordance with an exemplary embodiment, the cropped image (or text) is superimposed beneath the editable field 520 in the table or list 530. Furthermore, only the cropped image 540 upon which the editor is currently reviewing or editing on the right side of the display (or display window) is displayed.

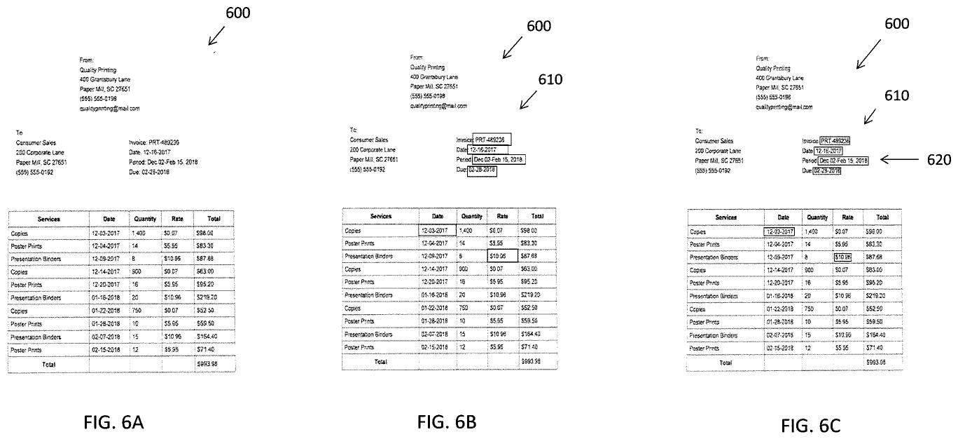

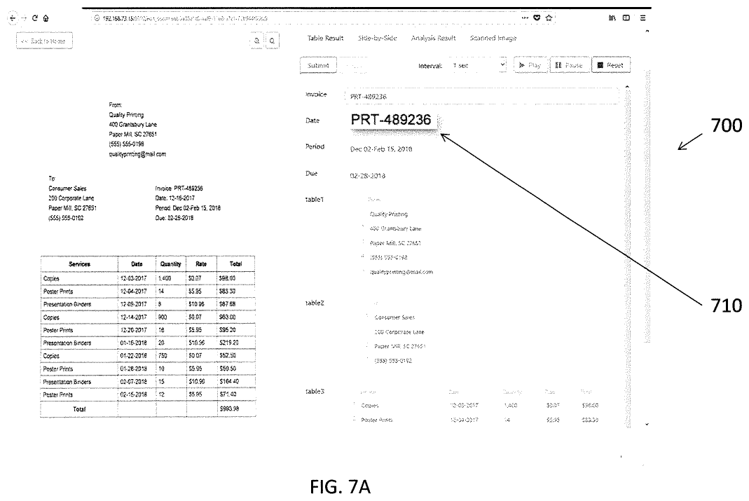

FIG. 6A is an illustration of an image 600 to be processed by the OCR/ICR processing module or software application in accordance with an exemplary embodiment. As shown in FIG. 6A, the image 600 to be processed can include text, tables, and numbers, which are arranged on different portions of an image. In accordance with an exemplary embodiment, for example, for documents or images, which are not available in an electronic format, the document or images can be placed on the scanner 106 of a printer or image forming apparatus 100 as shown in FIG. 1, and which can be processed (or converted) with the OCR/ICR program into an electronic image.

FIG. 6B is an illustration of exemplary predefined regions of interests (ROIs) 610 in accordance with an exemplary embodiment. As shown in FIG. 6B, the image 600 can include a plurality of predefined regions of interests (ROIs) 610. The predefined regions of interests (ROIs) 610 can include, for example, on a billing invoice, information such as addresses, invoice numbers, dates, period, due dates, etc. that generally difficult to OCR/ICR due to the presence of numbers and/or number sequences that cannot be easily verified with a spell check or other known application program that flags or identifies words in a document that may not be spelled correctly.

FIG. 6C is an illustration of the exemplary predefined regions of interests are OCR/ICR processing having bounding boxes 620. As shown in FIG. 6C, the OCR/ICR program can be configured to compute certain of the plurality of predefined regions of interests (ROIs) 610 as a more strict region (or bounding bod) having a target text string (for example, a word, words, multiple lines, etc.). In accordance with an exemplary embodiment, the bounding box information (i.e., result of the OCR/ICR can include x, y, width, height, or top-left and bottom right information) which is saved. In accordance with an exemplary embodiment, if the original scanned images are skewed and/or shrunk, an adjustment (image registration) can be performed by the OCR/ICR program before converting the image or text into an editable document.

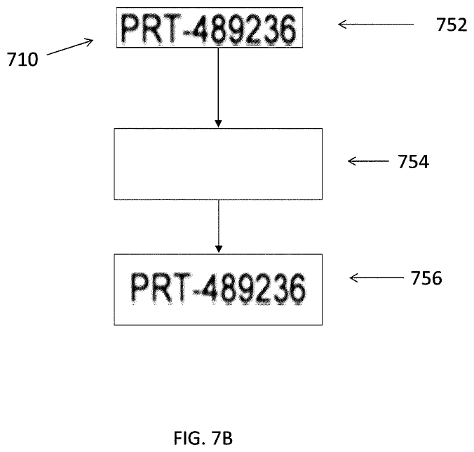

FIG. 7A is an illustration of a cropped text image display 700 in accordance with an exemplary embodiment. As shown in FIG. 7A, the cropped image 710 from the original image is superimposed (i.e., displayed) on the right side of the page (or window) in a general vicinity, for example, below the editable table or list.

As shown in FIG. 7B, the cropped image 710 is prepared by extracting the text or image in step 752 from the original image as a strict bounding box (i.e., the bounding box information is sized to be equal to the region of interest). In step 754, a field item which is larger than the strict bounding box information (i.e., the size of the field is emphasized) is prepared, and in step 756 the cropped image is then placed in the display window to be viewed by the editor as shown in FIG. 7B. As shown, the text or image extracted from the original image can be sized to a desirable size and a bounding box having a boundary (i.e., white space) is placed around the extracted text or image to assist the editor in comparing the cropped image (or bounding box) 710 to the corresponding editable field.

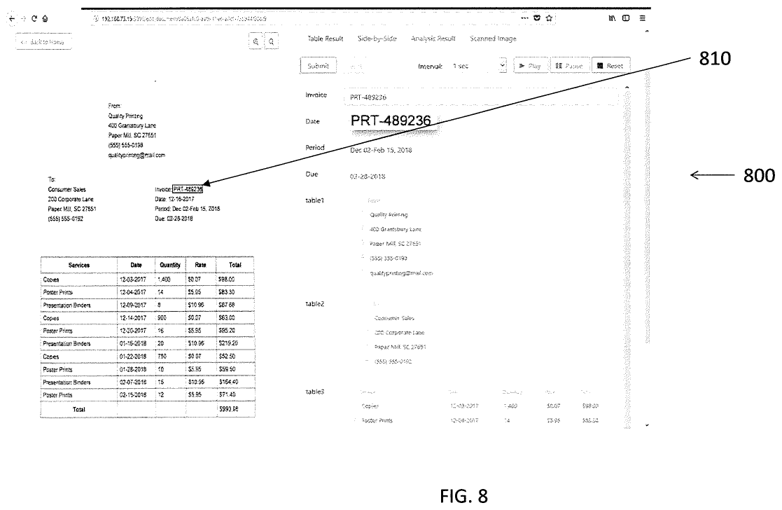

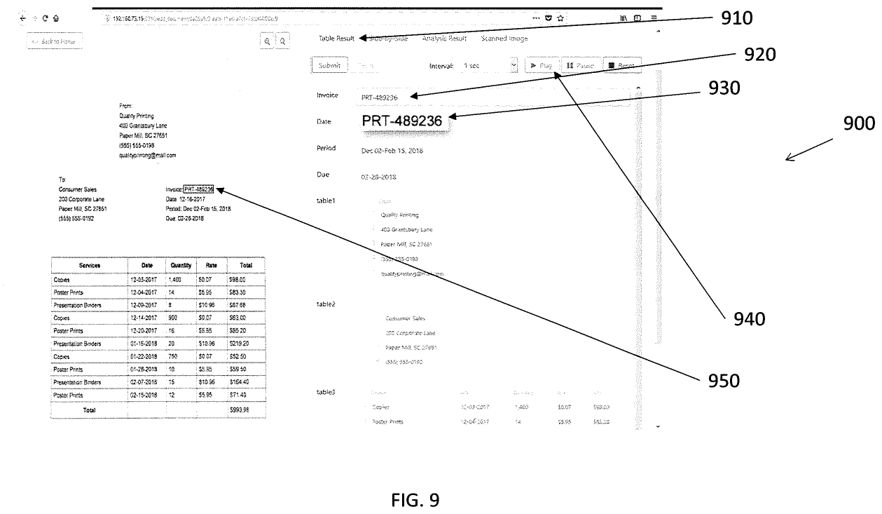

FIG. 8 is an illustration of a bounding box display 800 in accordance with an exemplary embodiment. As shown in FIG. 8, since the original image is resized to fit on the left side, the strict bounding box information can be amended based on a scale factor and/or an offset. The bounding box is than displayed on the left-side of the window.

FIG. 9 is an illustration of a cropped text image display 900 in accordance with an exemplary embodiment. As shown in FIG. 9, once the OCR/ICR program has generated the editable image (i.e., machine-encoded text), the results from the generated editable image are displayed as a table. In accordance with an exemplary embodiment, the size of the cropped text image from the original image can be adjusted, for example, the font size of the cropped text image can be increased or decrease in font size in accordance with a desired appearance. For example, in accordance with an exemplary embodiment, the font size of the cropped text image as shown on the results table is preferably a similar size or larger, for example, a same font size to eight font size larger, and more preferably four (4) font sizes larger than the font size depicted of the editable image in the table. In addition, the corresponding coordinates (x-coordinate, or x and y-coordinates) for the cropped text image are aligned such that the cropped text image can be placed below the editable field when the editable field is on an upper half of the display and can be placed above the editable field when the editable field is on a lower half of the display. In addition, the editable field can include a button in which the recognized text is played or spoken using a text to speech software application.

In addition, in accordance with an exemplary embodiment, since an entirety of the document image is displayed on the left side of the window, the editor can recognize or know which portions of the document is being edited. In accordance with an exemplary embodiment, the entirety of the document can be an entire document, or alternatively, the entire document can be a page of a longer multi-page document.

For example, in accordance with an exemplary embodiment, as shown in FIG. 9, a text image can be cropped from an original document image by performing an OCR/ICR operation on the original document based upon the predefined regions of interest (ROIs) of a designated form. The OCR/ICR can compute more strict regions (bounding boxes) of target text strings (for example, a word, words, multiple lines, etc.). The bounding box information is saved along with the results of the OCR/ICR process. If the original scanned images are, for example, skewed and/or shrunk, an adjustment (image registration or image resolution) to the skewed and/or shrunk images can be made before the OCR/ICR process is performed.

The cropped text image can be display on a page or window, (for example, right-side of display unit or graphical user interface (GUI)) in accordance with following steps. The editor moves focus to a form item which he/she intends to validate. Each form item (text field) stores the coordinate of a bounding box (x, y, width, height, or top-left and bottom-right) when the region of interest undergoes OCR/ICR processing. An image strict to the bounding box is cropped, and a field item is prepared, the field item being larger than the bounding box size, and the cropped image is placed in the middle of the bounding box so that cropped image can have some margin around the text and/or image. The cropped image is then placed to either right above or below the editable field which the editor intends to work on. In accordance with an exemplary embodiment, the cropped image's x-coordinate and the editable field's x-coordinate are aligned. However, if the size of cropped image is too large or small, the cropped image can be resized to a desired appearance relative to the editable field. In addition, since the cropped image item sticks to a certain position of an editable text page in a scrollable panel, if a page scrolls the cropped image moves, too.

In accordance with an exemplary embodiment, a bounding box display on an original image or page (left-side) can be calculated by a scale factor and an offset (for example, a shift in x- and y-coordinates) of a currently displayed image on the left side relative to an original size of the image. A resized bounding box is calculated based upon the scale factor and/or an offset. The resized bounding box is superimposed (or overlaid) on the left-side image to indicate which part the editor currently working on (validating and/or correcting). Thus, by placing the cropped image near the editable field, validity of the OCR/ICR document can be increased.

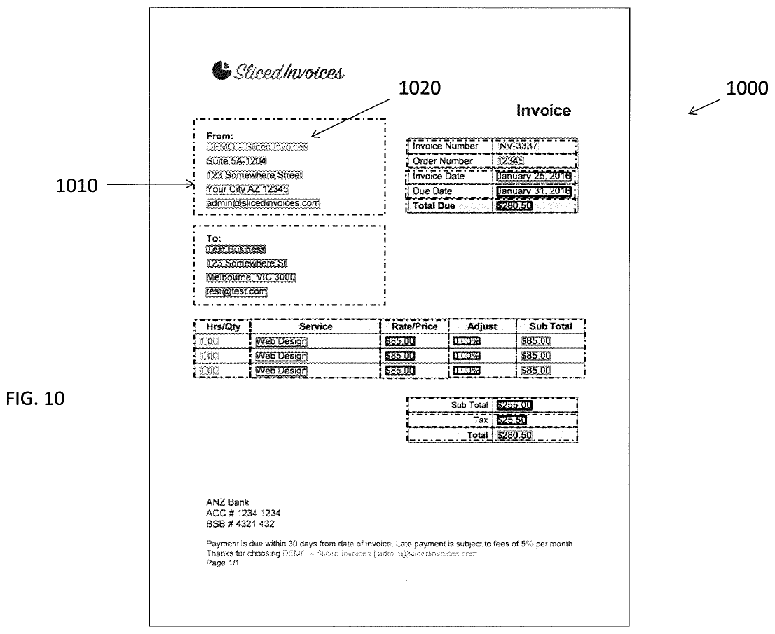

FIG. 10 is an illustration of a bounding box visualization 1000 in accordance with an exemplary embodiment. As shown in FIG. 10, in accordance with an exemplary embodiment, a region of interest 1110, for example, dashed line boundaries indicating a predefined region of interest for an OCR/ICR process can be saved in the application program. In accordance with an exemplary embodiment, the OCR/ICR process can be performed only in those regions of interest 1010 that have been designated by the editor as a region of interest. In accordance with an exemplary embodiment, after OCR/ICR processing, line segmentations are computed as (visualization as boxes with colored lines). As shown in FIG. 10, lines 1020 with, for example, a same color or pattern belong to a same predefined region of interest 1010. Thus, each colored-line region (i.e., region of interest”) has a corresponding editable field on the right side of the display page. In accordance with an exemplary, cropped images attached to the editable fields are computed by the regions of interest 1020.

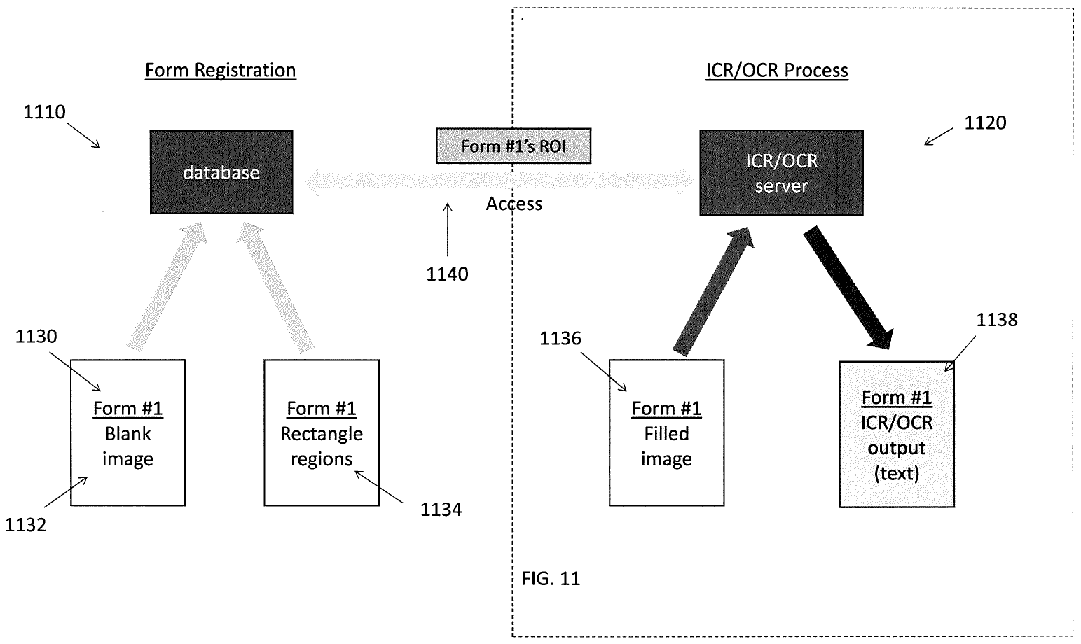

FIG. 11 is an illustration of a registration process 1110 and an OCR/ICR process 1160 in accordance with an exemplary embodiment. As shown in FIG. 11, the registration process 1110 for a form (Form #1) 1120, for example, an invoice, can be saved into a database 1120. In accordance with an exemplary embodiment, the form 1130 in an original format (i.e., blank image) 1132 is saved into the database 1120. For example, the form 1120 can be a fillable form. The fillable form being a frequently used and/or modified document that available in an electronic format and/or in paper format having spaces in which a user writes or selects, for a series of document with similar contents. In addition, regions of interest 1134 are designated on the blank form and coordinates of each of the regions of interest and one or more regions of the region of interest that have been designated as a target region (i.e., bounding box region) are sent to the database 1110. In accordance with an exemplary embodiment, the database 1110 can be hosted on the image forming apparatus 100, the client device 300, or a separate server or computer (not shown).

In accordance with an exemplary embodiment, the OCR/ICR process can be performed by the image forming apparatus 100, the client device 300, or a designated ICR/OCR server 1120. If the OCR/ICR process is performed on a separate ICR/OCR server 1120, the ICR/OCR server 1120 is preferably in communication with the client device 300 via network 200.

As shown in FIG. 11, in accordance with an exemplary embodiment, the form with filled images (i.e., text or images) 1136 can be input into the ICR/OCR server 1120 for character recognition processing. In accordance with an exemplary embodiment, the ICR/OCR server 1120 can access the database 1110 to retrieve the predefined regions of interest 1134 for the form 1130 and the process the filled form 1136 as disclosed herein. The ICR/OCR server 1120 generates the editable document 1138 based on the predefined regions of interests retrieved from the database 1110 to produce the editable document in a table or list format as disclosed herein.

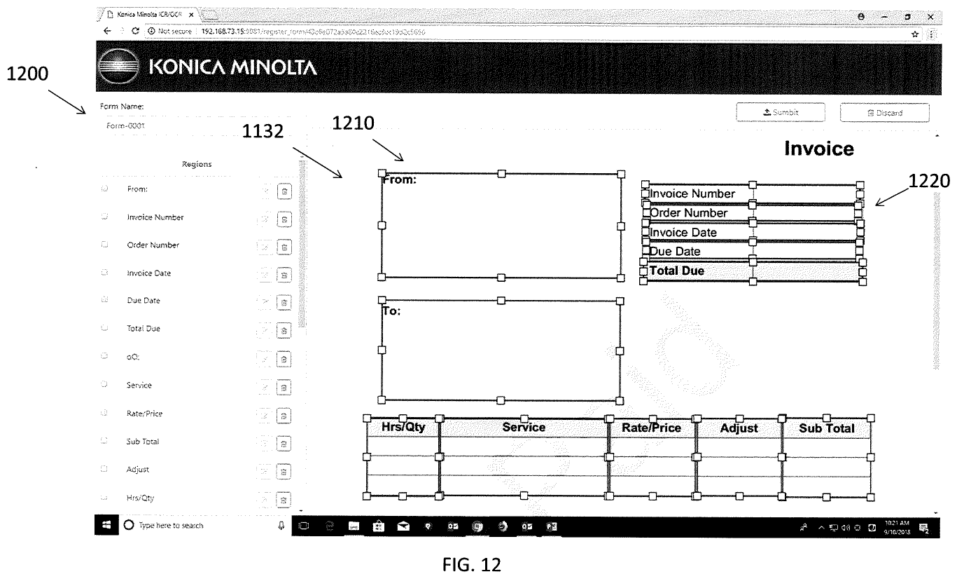

FIG. 12 is an illustration of a portion of the registration process in accordance with an exemplary embodiment on a display screen or window 1200. As shown in FIG. 12, the original image 1130 can be a blank form 1132, for example, an invoice, which can be input into the database via, for example, an OCR/ICR process. The blank form 1130 can be converted into an editable version 1210 in which the editor can select the predefined regions of interest 1220, and corresponding more strict regions or target regions (i.e., bounding boxes) of a target text strings 1220 (e.g. a word, words, multiple lines, etc.).

In accordance with an exemplary embodiment, the methods and processes as disclosed can be implemented on a non-transitory computer readable medium. The non-transitory computer readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for displaying images from a character recognition application on a display window, the method comprising:
uploading an original image to be processed by a character recognition program;
designating one or more regions on the original image as regions of interest;
converting the original image into an editable document using the character recognition program, each of the regions of interest being converted into a corresponding editable field;
displaying the original image on one portion of the display window, and the editable document in a table on an other portion of the display window; and
validating the editable document by comparing an image of a region of interest from the original image with the corresponding editable field by superimposing the image of the region of interest on the other portion of the display window.

2. The method according to claim 1, further comprising:
designating the one or more regions on the original document as the regions of interest before the uploading of the original image for processing.

3. The method according to claim 1, further comprising:
performing the character recognition program only on the regions of interest.

4. The method according to claim 1, further comprising:
designating the regions of interest in the original document before performing the conversion of the original image into the editable document;
saving the regions of interest in the original document in a database; and
retrieving the regions of interest from the database during the conversion of the original image into the editable document.

5. The method according to claim 1, further comprising:
displaying a cropped image from the original image of the corresponding editable field on the display window, the cropped image being an image of the region of interest from the original image, and wherein the cropped image is displayed either above or below the corresponding editable field.

6. The method according to claim 5, further comprising:
editing the corresponding editable field in the table when the cropped image is not an accurate conversion of the original image.

7. The method according to claim 5, further comprising:
moving a cursor on the editable document between each of the corresponding editable fields in the table; and
displaying only the cropped image for the corresponding editable field in which the cursor is adjacent.

8. The method according to claim 5, further comprising:
resizing the cropped image having a font size that is a same or not more than 4 font sizes larger than a font size of text or images in the corresponding editable field.

9. The method according to claim 1, further comprising:
highlighting the region of interest on the original image corresponding to the editable field with a cursor.

10. The method according to claim 1, further comprising:
predefining the regions of interest on the original image, and wherein the original image is a form having one or more spaces to be completed by a user.

11. A non-transitory computer readable medium storing computer readable program code executed by a processor for displaying images from a character recognition application on a display window, the process comprising:
uploading an original image to be processed by a character recognition program;
designating one or more regions on the original image as regions of interest;
converting the original image into an editable document using the character recognition program, each of the regions of interest being converted into a corresponding editable field;
displaying the original image on one portion of a display window, and the editable document in a table on an other portion of the display window; and
validating the editable document by comparing an image of a region of interest from the original image with the corresponding editable field by superimposing the image of the region of interest on the other portion of the display window.

12. The non-transitory computer readable medium according to claim 11, further comprising:
designating the one or more regions on the on the original document as the regions of interest before the uploading of the original image for processing.

13. The non-transitory computer readable medium according to claim 11, further comprising:
performing the character recognition program only on the regions of interest.

14. The non-transitory computer readable medium according to claim 11, further comprising:
designating the regions of interest in the original document before performing the conversion of the original image into the editable document;
saving the regions of interest in the original document in a database; and
retrieving the regions of interest from the database during the conversion of the original image into the editable document.

15. The non-transitory computer readable medium according to claim 11, further comprising:
displaying a cropped image from the original image of the corresponding editable field on the display window, the cropped image being an image of the region of interest from the original image, and wherein the cropped image is displayed either above or below the corresponding editable field.

16. The non-transitory computer readable medium according to claim 15, further comprising:
editing the corresponding editable field in the table when the cropped image is not an accurate conversion of the original image.

17. The non-transitory computer readable medium according to claim 15, further comprising:
moving a cursor on the editable document between each of the corresponding editable fields in the table; and
displaying only the cropped image for the corresponding editable field in which the cursor is adjacent.

18. The non-transitory computer readable medium according to claim 15, further comprising:
resizing the cropped image having a font size that is a same or not more than 4 font sizes larger than a font size of text or images in the corresponding editable field.

19. A system for displaying images from a character recognition application, the system comprising:
a client device having a display window, and a processor configured to:
upload an original image to be processed by a character recognition program;
designate one or more regions on the original image as regions of interest;
convert the original image into an editable document using the character recognition program, each of the regions of interest being converted into a corresponding editable field;
display the original image on one portion of the display window, and the editable document in a table on an other portion of the display window; and
validate the editable document by comparing an image of a region of interest from the original image with the corresponding editable field by superimposing the image of the region of interest on the other portion of the display window.

20. The system according to claim 19, further comprising:
an image forming apparatus configured to scan the original image into a format that can be converted by the character recognition program into an editable document.
